(19) United States
(12) Patent Application Publication
(10) Pub. No.: US 2010/0218356 A1
(43) Pub. Date: Sep. 2, 2010

(54) Extraction Tool and Method For Extracting A Wire Thread Insert

(76) Inventors: Uwe Kirchhecker, Steinhagen (DE); Peter Kühnel, Bielefeld (DE)

Correspondence Address: SEYFARTH SHAW LLP, 131 S. DEARBORN ST., SUITE 2400, CHICAGO, IL, 60603-5803, US

(21) Appl. No.: 12/713,875

(22) Filed: Feb. 26, 2010

(30) Foreign Application Priority Data
Feb. 27, 2009 (DE) 10 2009 010 760.6

(51) Int. Cl. B23Q 1/00; B23P 19/00

(52) U.S. Cl. 29/283; 29/426.5

(57) ABSTRACT

The present invention discloses an extraction tool and a method for extracting a wire thread insert. The extraction tool comprises a spindle body having a drive section for rotating the spindle body, and having an unscrew section for extraction of the wire thread insert. The unscrew section has a cylindrical shape with an exterior and a longitudinal axis, beyond whose exterior only one cutting element extends radially. This cutting element notches and engages the wire thread insert in order to extract it then from a tapped bore of a component.

### 1. FIELD OF THE INVENTION

The present invention relates to an extraction tool and a method for extracting a wire thread insert from a component.

### 2. BACKGROUND OF THE INVENTION

Wire thread inserts are versatile for applications in technology. Their area of application extends from aerospace technology to mechanical engineering, and to medical and electrical engineering. In this context, wire thread inserts are inserted into components of the most varied materials. In addition, wire thread inserts of different lengths are used, and sometimes installed to different depths in tapped bores.

In order to extract wire thread inserts, they are, for example, extracted with a manually actuated extraction tool. This extraction tool comprises a spindle body, to which a triangular cutting element is fastened at one end. During unscrewing of the wire thread insert using this extraction tool, two blades, disposed opposite each other and extending toward each other, engage into the threads of the wire thread insert facing the extraction tool. After the opposite lying blades have engaged in these windings of the wire thread insert, the wire thread insert is unscrewed in its direction of winding.

According to a further alternative, an extraction tool consists of a spindle body, which narrows at one end similar to a spike, and tapers with three cutting edges. The diameter of the spindle body is larger than the inner diameter of the wire thread insert to be extracted. Thereby, it is possible that during insertion of the spike into the wire thread insert the three cutting edges of the extraction tool wedge into the wire thread insert. For this purpose, the extraction tool is pressed into the wire thread insert. The wire thread insert is extracted with the subsequent rotation of the extraction tool.

In the examples of extraction tools for wire thread inserts described above, it is disadvantageous that these extraction tools expand the windings of the wire thread insert facing the extraction tool. This results in damage to the thread in the component. In addition, the wire thread insert frequently wedges in the material of the component, which impedes the extraction of the wire thread insert. A further disadvantage consists in that the extraction tool engages only the upper windings of the wire thread insert. If the wire thread insert is now unscrewed, its part facing away from the extraction tool constricts, which can lead to the breakage of the wire thread insert. Furthermore, wire thread inserts inserted deeply in the bores can be extracted with the known extraction tools only with the simultaneous damaging of the bore in the component. The same is true for wire thread inserts that have broken in the initial phase of the extraction due to constriction.

Therefore, it is the object of the present invention to provide an extraction tool and a method for extracting a wire thread insert, with which a wire thread insert can be extracted with high reliability of the method, and with reduced component damage in comparison to the state of the art.

### 3. SUMMARY OF THE INVENTION

The above named problem is solved by an extraction tool according to patent claim 1, and by an extraction method for a wire thread insert according to patent claim 9. Advantageous designs of the present invention arise from the following description, the drawings and the dependent claims.

The extraction tool according to the invention for a wire thread insert has the following features: a spindle body having a drive section for rotating the spindle body, and having an unscrew section for the extraction of the wire thread insert, where the unscrew section comprises a cylindrical shape with an exterior and a longitudinal axis, where only a radial cutting element projects beyond said exterior, so that the wire thread insert can be engaged by the cutting element, and a support surface can be provided for the wire thread insert with the exterior of the unscrew section facing away from the cutting element.

In comparison to the known extraction tools for wire thread inserts, the present invention functions similarly with a rotational movement in order to extract a wire thread insert from a tapped bore in a component. For this purpose, at an unscrew section of cylindrical shape, only one blade is deployed, which preferably catches due to notching in the winding of the wire thread insert facing the blade. The cylindrical section of the unscrew section, which is located opposite from the cutting element, serves as a support surface for the wire thread insert so that it is not pressed radially outwards by the cutting element. In this way, it is prevented that the wire thread insert is pressed into the material of the component, and catches there obstructing the extraction. In addition, the support surface of the unscrew section disposed facing away from the cutting element has the optional function to support the wire thread insert over its entire length during extraction. In this manner, a partial constriction of the wire thread insert is permitted for aiding the extraction of the wire thread insert. However, at the same time, the constriction is limited insofar as a tearing off or breaking off of the wire thread insert is prevented because during constriction, the wire thread insert preferably wraps around the unscrew section of the extraction tool.

According to a preferred embodiment of the present extraction tool, the unscrew section comprises a slot, running parallel to its longitudinal axis, in which the cutting element is held axially movable.

The axial movement of the cutting element in relation to the longitudinal axis of the unscrew section of the extraction tool guarantees any adjustment of the extraction tool to wire thread inserts of different lengths. While the cutting element can engage the wire thread insert at the end facing toward it, the cylindrical support surface acts on the side of the unscrew section facing away from the cutting element as a support over the entire length of the wire thread insert. With this design basis, the extraction of wire thread inserts of different lengths is possible with equal efficiency and quality. The movability of the cutting element is preferably realized in that the unscrew section comprises a centrally disposed bore with an internal thread. Within this bore, the cutting element can be positioned axially using at least one screw element.

According to a further embodiment of the present invention, the cutting element of the extraction tool has a blade, which is disposed at an angle to the longitudinal axis of the unscrew section such that only a winding of the wire thread insert located closest to the blade can be engaged, in particular, notched.

Based on the suitable selection of the angle of the cutting element, an unnecessary spreading of the wire thread insert by the cutting element is prevented. Thereby, the force applied by the cutting element in the radial direction on the wire thread insert is used mainly for notching the winding of the wire thread insert facing the cutting element. While in this manner on the one hand, a fixed hold of the cutting element is created at the wire thread insert, on the other hand, the force with which the wire thread insert is pressed into the material of the component is reduced. Since for this reason the wire thread insert is not caught more strongly in the material of the component than is the case due to the normal hold through static friction, during extraction of the wire thread insert, the extraction tool needs not to overcome any self generated resisting force due to material surrounding the wire thread insert. Thus, the extraction of the wire thread insert is also supported in this manner.

In this context, it is further preferable that the cutting element has a blade, which is disposed in relation to the longitudinal axis of the unscrew section at an angle that lies between 10° and 30°, preferably between 18° and 24°, and further preferably at 22°.

According to a further embodiment of the present invention, the maximum diameter of the unscrew section in the area of the radially projecting cutting element is defined such that a thread in a tapped bore of a component cannot be damaged with the unscrew section inserted parallel to the longitudinal axis of the tapped bore. This is guaranteed with the following design. On the one hand, the support surface, located at the side of the unscrew section facing away from the cutting element, supports the interior of the wire thread insert. If this is the case, the cutting element may project radially over the exterior of the unscrew section only to the extent that the wire thread insert can be engaged using the cutting element, however the thread in the tapped bore of the component cannot be damaged. Therefore, the cutting element projects maximally only up to the thread of the tapped bore, so that it cannot reach the thread. This design guarantees that also wire thread inserts inserted deeply in longer tapped bores can be extracted without the extraction tool damaging the thread of the tapped bore. This extends the service life of the component, and in addition supports the replacement of wire thread inserts in any length tapped bores, if, for example, the wire thread inserts happen to be damaged.

The present invention also discloses a method for extracting a wire thread insert from a tapped bore of a component. This extraction method comprises the following steps: application of a cylindrically shaped extraction tool with cutting element to the wire thread insert, where the cutting element projects radially beyond the exterior edge at only one circumferential position relative to the extraction tool, notching of the wire thread insert using the cutting element at only one circumferential position relative to the wire thread insert, and extraction of the wire thread insert from the tapped bore by rotation of the extraction tool in the winding direction of the wire thread insert.

Within the context of the extraction method it is preferred to apply the cutting element at an angular range of 10° to 140°, preferably 40° to 90°, and further preferably at an angle of 90°, measured in the clockwise direction from the end of the winding of the wire thread insert facing the extraction tool. Then, the cutting element is pressed into the wire thread insert so that the winding of the wire thread insert facing the extraction tool is notched by the cutting element. Due to the specific angular range of the application and notching of the wire thread insert by the cutting tool it is achieved that during extraction from the bore, the wire thread insert is not pressed into the material of the component. In this way damages to the tapped bores in the component are avoided.

According to a further preferred embodiment the extraction method comprises the following step: adjustment of the axial position of the cutting element such that the extraction tool extends beyond the cutting element, especially up to the end of the wire thread insert facing away from the cutting element, when the cutting element engages the wire thread insert.

Using this pre-adjustment of the extraction tool, the function of the support surface at the side of the unscrew section facing away from the cutting element is guaranteed. Because the unscrew section preferably extends over the entire length, or at least the majority of the length, of the wire thread insert, in this manner a constriction that is too strong up to a breaking off of the wire thread insert is prevented during the unscrewing, while simultaneously a constriction for facilitating extraction of the wire thread insert is supported. During the unscrewing, the wire thread insert wraps around the unscrew section of the extraction tool so that it neither bends nor distorts. Therefore, the extraction method preferably comprises also the step: during the extraction of the wire thread insert, support of the wire thread insert at a cylindrical exterior wall of the extraction tool facing away from the cutting element.

### 4. BRIEF DESCRIPTION OF THE ACCOMPANYING DRAWINGS

The present invention is described in more detail with reference to preferred embodiments represented in the accompanying drawings. They show:

FIG. 1 a sectional representation of a preferred embodiment of the extraction tool during insertion in a tapped bore with a wire thread insert,

FIG. 2 an exploded representation of a preferred embodiment of the extraction tool,

FIG. 3 an enlarged representation of the fastening and movement of the cutting element in the extraction tool according to FIG. 1,

FIG. 4 a schematic representation of the extraction tool applied at a wire thread insert,

FIG. 5 top view of a wire thread insert,

FIG. 6 schematic enlarged view of a blade of a cutting element of the preferred extraction tool,

FIG. 7 flow diagram for illustration of a preferred embodiment of the extraction method according to the invention.

### 5. DETAILED DESCRIPTION OF THE PREFERRED EMBODIMENTS OF THE INVENTION

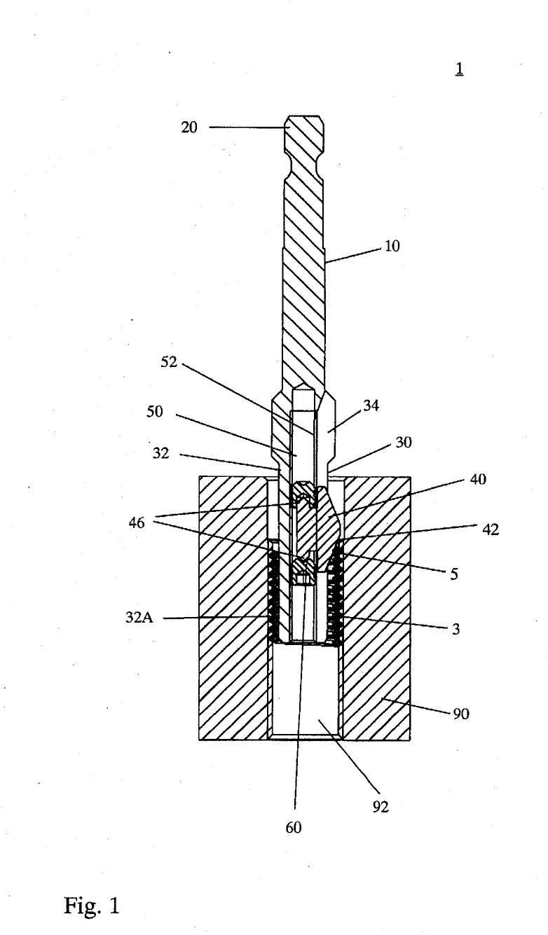

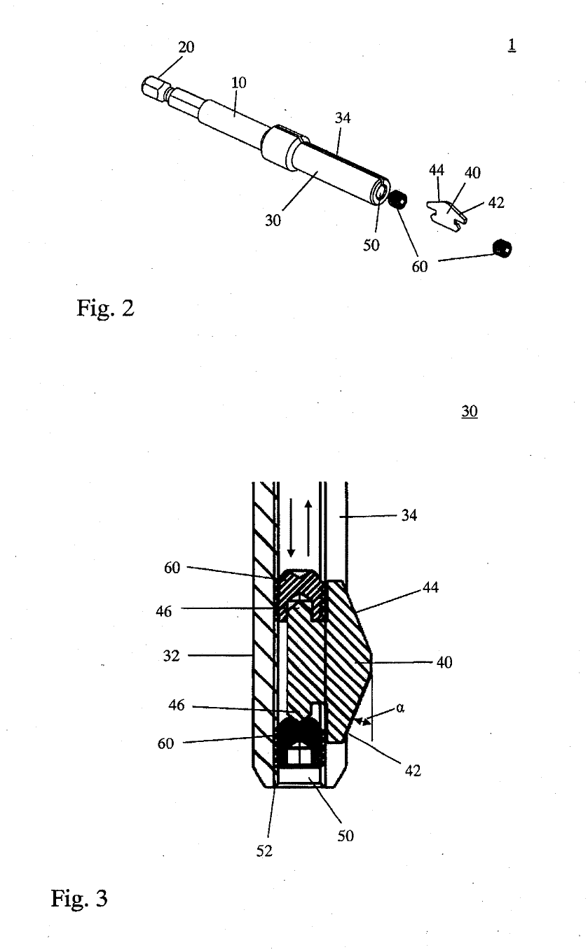

A preferred embodiment of the extraction tool 1 according to the invention is shown in a sectional representation in FIG. 1. The extraction tool 1 comprises a spindle body 10, at whose opposite ends a drive section 20 and an unscrew section 30 are disposed. The drive section 20 comprises, for example a handle (not shown) for manual operation of the extraction tool 1. According to a further alternative, a hexagon head, as can be seen also in FIG. 2, is provided as a drive means in the drive section 20. Known types of tools can be applied at this hexagon head in order to actuate the extraction tool 1. According to a further embodiment, it is possible to connect a motorized drive to the extraction tool 1, and to operate it in this manner.

The unscrew section 30 has a cylindrical shape with an exterior 32. A bore 50 with an internal thread 52 is disposed coaxially to the longitudinal axis of the unscrew section 30. Preferably, two screw elements 60, matched to the internal thread 52, are screwed into the bore 50. These screw elements 60 hold a cutting element 40 (see FIG. 3) at a preselected axial position of the unscrew section 30. For this purpose, the cutting element 40 has, for example, two pin-like arrangements 46, at which the two screw elements 60 engage (see FIGS. 1 to 3).

The cutting element 40 is disposed in a slot 34 running in the longitudinal direction of the unscrew section 30. It extends beyond the radial exterior 32 of the unscrew section 30.

The cutting element 40 can be freely positioned along the longitudinal axis of the unscrew section 30 by means of the screw elements 60. This is indicated by the arrows in FIG. 3. In comparison to the screw elements 60, it is also preferred to position and hold the cutting element 40 with only one screw element 60. Furthermore, the cutting element 40 could be fastened within the unscrew section 30 using one or two snap elements (not shown). For this purpose, the snap elements would be able to lock at specific locations within the bore 50 without threads, and can move freely in both directions. According to a further alternative, instead of the bore 50, the slot 34 extends up to the interior of the unscrew section 30. Preferably, the snap elements (not shown) are guided within this slot, and can be locked at specific locations in order to hold the cutting element 40.

As highlighted in FIG. 3, the cutting element 40 comprises at least one blade 42. Preferably, the cutting element 40 is formed symmetrically so that it has two blades 42, 44. These two blades 42, 44 can be exchanged with each other through rotation of the cutting element 40 by 180° about its transverse running axis of symmetry (see FIG. 3).

The one blade 42 of the cutting element 40 nearest to the wire thread insert 3, is disposed at a specific angle α in relation to the longitudinal axis of the unscrew section 30. Due to this specific angle α, the wire thread insert 3 can be engaged with the blade 42 when the extraction tool 1 is inserted into the tapped bore 92 of the component 90. When the unscrew section 30 is pressed into the wire thread insert 3, the blade 42 creates a notch in the wire thread insert 3. As soon as the extraction tool 1 is rotated about its longitudinal axis in the direction of winding of the wire thread insert 3, the blade 42 takes along the wire thread insert 3 using the created notch.

According to a preferred embodiment, the angle α between the longitudinal axis of the unscrew section 30 and the blade 42 is adjusted such that only the winding 5 of the wire thread insert 3 located nearest the blade 42 is engaged. During pressing of the extraction tool 1 into the tapped bore 92, only the winding 5 located nearest the blade 42 is notched and then engaged, in order to extract the wire thread insert 3 from the component 90. According to a preferred embodiment, the blade 42 is disposed at an angle α in relation to the longitudinal axis of the unscrew section 30, where a lies between 10° and 30°, preferably between 18° and 24°, and further preferably at 22°.

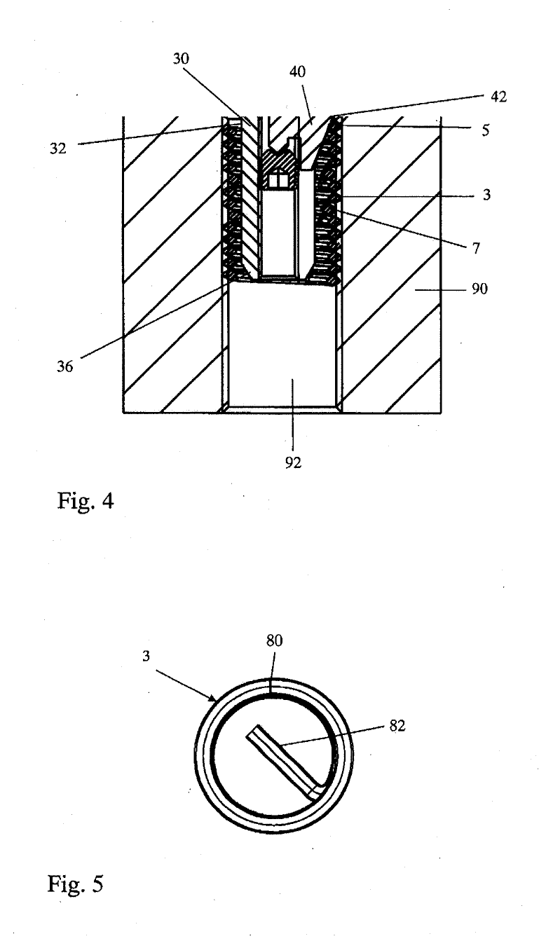

The notching and engaging of only the winding 5 of the wire thread insert 3 located nearest the blade 42 is also illustrated in FIG. 4. While the blade 42 engages the winding 5 of the wire thread insert 3, the wire thread insert 3 is supported by the support surface 32 at the exterior 32a of the unscrew section 30 facing away from the cutting element 40. Because the support surface 32 extends beyond the cutting element 40, preferably over the entire length of the wire thread insert 3 (see FIG. 1), a constriction that is too strong and thereby favors tearing off the wire thread insert 3 during its extraction from the component 90 is prevented.

In the embodiment shown in FIG. 4, the wire thread insert 3 comprises two windings 7 with smaller diameters in comparison to the remaining windings. These windings 7 with their smaller diameter serve in a known manner as screw locking in wire thread inserts 3. In order to provide a sufficiently large support surface 32 also with these wire thread inserts 3, the diameter of the unscrew section 30 at the height of the cutting element 40 is selected such that the support surface 32 initially supports only the interior of the winding 7, while the unscrew section 30 extends over the entire length of the wire thread insert 3. With this, the blade 42 of the cutting element 40 does not reach the thread at the interior of the bore 92. In addition, the unscrew section 30 preferably tapers at its free end, for example, over a conical surface 36 in order to allow a deeper insertion into the bore 92. Thus, with the use of the extraction tool 1 for the wire thread insert 3, the extraction tool 1 is inserted so far into the wire thread insert 3 that the tapered end of the unscrew section 30 preferably is supported at the foot of the bore 92, or ends shortly before it. During the extraction of the wire thread insert 3 by rotation of the unscrew section 30 using the drive means 20, initially the windings 7 are supported at the support surface 32. Because during the unscrewing of the wire thread insert 3, a constriction of the wire thread insert 3 takes place, after further rotation of the extraction tool 1 about its longitudinal axis, further windings, and preferably the majority of the windings or even all windings of the wire thread insert 3 are supported at the support surface 32. Through this controlled constriction of the wire thread insert 3, its diameter is reduced and its extraction is facilitated without tearing off or breaking away the wire thread insert.

In order to prevent damaging the thread in the tapped bore 92 of the component 90, the maximum diameter of the unscrew section 30 in the area of the radially projecting cutting element 40 is expediently adjusted, as was already explained above. The maximum diameter at this location of the unscrew section 30 is selected such that with the unscrew section 30 inserted parallel to the longitudinal axis of the tapped bore 92, the thread in the tapped bore 92 of the component 90 is not reached by the blade 42 of the cutting element 40. This applies for the cases that the support surface 32 is supported initially at the windings 7 of smaller diameter, or already over a portion, or the entire length, of the wire thread insert 3 without smaller windings 7. In this manner, it is guaranteed that the cutting element 40 does not damage the thread in the tapped bore 92 of the component 90. For this purpose, the diameter d of the unscrew section 30 in the area of the radially projecting cutting element 40, is defined such that it is greater than an interior diameter id₃ of the wire thread insert 3, and smaller than the sum of an interior diameter d₉₂ of the tapped bore 92 of the component 90 and the interior diameter id₃ of the wire thread insert 3 divided by two. This is summarized in a formula as

$${id}_{3} < d < \frac{{d}_{92} + {id}_{3}}{2} .$$

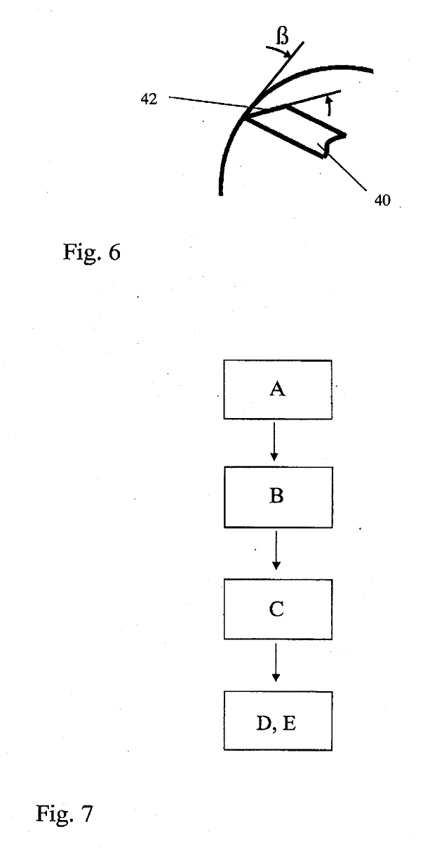

It is further preferable to sharpen the blade 42 at a clearance angle β (see FIG. 6). This sharpening of the blade 42 supports the notch effect of the blade 42 during pressing of the extraction tool 1 into the wire thread insert 3 to be extracted. The clearance angle β is measured between the blade 42 and the tangent at the contact point of the blade 42 at the wire thread insert 3. Preferably, the angle lies between 8° and 15°, while other clearance angles are also conceivable, so long as they supports the notching by the blade 42 in the wire thread insert 3. According to a most preferred embodiment, a clearance angle of 12° is used.

For the extraction of the wire thread insert 3 from the tapped bore 92 of the component 90, initially an adjustment (step A) of the axial position of the cutting element 40 with respect to the longitudinal axis of the unscrew section 30 occurs. The position of the cutting element 40 is selected such that the extraction tool 1 with its unscrew section 30 extends beyond the cutting element 40 in the direction of the end of the wire thread insert 3 facing away from the cutting element 40, when the cutting element 40 engages the wire thread insert 3. It is preferred that the extraction tool 1 with its unscrew section 30 extends up to the end of the wire thread insert 3 facing away from the cutting element 40.

In a further step B (see FIG. 7), the cutting element 40 of the extraction tool 1 is applied at the wire thread insert 3. Because the cutting element 40 projects radially at only one circumferential position relative to the exterior 32 of the unscrew section 30, the blade 42 of the cutting element 40 contacts the wire thread insert 3 at only one position. The support surface, disposed at the exterior 32a of the unscrew section 30 facing away from the cutting element 40, simultaneously supports at the interior of the wire thread insert 3.

In a further step C, the wire thread insert is notched using the cutting element 40, specifically using the blade 42, at only one circumferential position relative to the wire thread insert 3. In order to guarantee an effective notching of the wire thread insert by the blade 42 of the cutting element 40, the unscrew section 30 of the extraction tool 1 is pressed in the axial direction into the wire thread insert 3. The notching of only the first winding 5 of the wire thread insert 3 located nearest to the cutting element 40 occurs at an angular range of 10° to 140°, preferably 40° to 90° and most preferred at a position of 90°. This angular range or angle is measured in the clockwise direction starting from the end 80 of the wire thread insert 3 facing towards the extraction tool 1 (see FIG. 5).

It has been shown that with contact of the extraction tool 1 at an angular position of greater than 140°, measured in the clockwise direction from the end 80 of the wire thread insert 3 facing towards the extraction tool 1, a extraction of the wire thread insert 3 is impeded. During the rotation of the extraction tool 1 in the direction of winding of the wire thread insert 3, there is a radial widening of the first winding 5 of the wire thread insert 3 facing towards the extraction tool 1. This, on the one hand, results in damaging the threads in the tapped bore 92, and on the other hand, increases the coefficient of friction between the wire thread insert 3 and the component 90. Additionally, it is possible that the free end of the wire thread insert 3 to be extracted catches in the material of the component 90, so that the wire thread insert 3 is compressed and blocked during the attempt to unscrew. With unscrewing of the wire thread insert and a previous placement in an angular range of 10° to 140° (see above), only a small radial widening of the wire thread insert in the winding 5 occurs. In addition, the wire thread insert 3 is radially reduced during its further progression by the rotation movement of the extraction tool 1, which supports the extraction. Thus, in step D the extraction of the wire thread insert 3 from the tapped bore 92 occurs by rotating the extraction tool 1 in the direction of winding of the wire thread insert 3 about the longitudinal axis of the extraction tool 1.

According to the further step E during the extraction of the wire thread insert 3, a support of the wire thread insert 3 occurs at the cylindrical exterior wall 32a of the extraction tool 1 facing away from the cutting element 40.

1. An extraction tool for a wire thread insert, which has the following features:
a. a spindle body with a drive section for rotating the spindle body and with an unscrew section for extracting the wire thread insert, while
b. the unscrew section comprises a cylindrical shape with an exterior and a longitudinal axis, beyond whose exterior only one cutting element radially projects, such that
c. the wire thread insert can be engaged with the cutting element, and with the exterior of the unscrew section facing away from the cutting element, a support surface can be provided for the wire thread insert.

2. The extraction tool according to claim 1, whose unscrew section comprises a slot running parallel to its longitudinal axis, where the cutting element is held axially movable in said slot.

3. The extraction tool according to claim 2, whose unscrew section comprises a centrally disposed bore with an internal thread, within which the cutting element is held and can be positioned axially by means of at least one screw element.

4. The extraction tool according to claim 1, whose cutting element comprises a blade, which is disposed in relation to the longitudinal axis of the unscrew section at an angle α such that only one winding of the wire thread insert located nearest to the blade can be engaged.

5. The extraction tool according to claim 1, whose cutting element comprises a blade, which in relation to the longitudinal axis of the unscrew section is disposed at an angle α that lies between 10° and 30°, preferably between 18° and 24°, and further preferably at 22°.

6. The extraction tool according to claim 1, whose cutting element has two blades disposed mirror symmetrically to each other.

7. The extraction tool according to claim 1, whose maximum diameter of the unscrew section in the area of the radially projecting cutting element is defined such that a thread in a tapped bore of a component cannot be damaged with the unscrew section inserted parallel to the longitudinal axis of the tapped bore.

8. The extraction tool according to claim 1, whose diameter of the unscrew section in the area of the radially projecting cutting element is defined as
$${id}_{3} < d < \frac{{d}_{92} + {id}_{3}}{2} ,$$
where id₃ describes an internal diameter of the wire thread insert and d₉₂ describes an internal diameter of the tapped bore in a component.

9. An extraction method for a wire thread insert from a tapped bore of a component having the following steps:
a. placement of a cylindrically shaped extraction tool with the cutting element at the wire thread insert, wherein relative to the extraction tool, the cutting element projects radially beyond its exterior edge at only one circumferential position,
b. notching of the wire thread insert using the cutting element at only one circumferential position relative to the wire thread insert,
c. extraction of the wire thread insert from the tapped bore by rotation of the extraction tool in a direction of winding of the wire thread insert.

10. The extraction method according to claim 9, in which the cutting element is applied in an angular range of 10°-140°, preferably 40°-90° and further preferably 90°, measured in the clockwise direction from the end of the wire thread insert facing the extraction tool, and is pressed into the wire thread insert so that the wire thread insert is notched by the cutting element.

11. The extraction method according to claim 9, which has the further step:
adjustment of the axial position of the cutting element such that the extraction tool extends in the longitudinal direction beyond the cutting element, or up to the end of the wire thread insert facing away from the cutting element, when the cutting element engages the wire thread insert.

12. The extraction method according to claim 9, which comprises the further step:
support of the wire thread insert at a cylindrical exterior wall of the extraction tool facing away from the cutting element during the extraction of the wire thread insert.
